(19) United States
(12) Patent Application Publication
(10) Pub. No.: US 2018/0121125 A1
(43) Pub. Date: May 3, 2018

(54) METHOD AND APPARATUS FOR MANAGING RESOURCE ACCESS CONTROL HARDWARE IN A SYSTEM-ON-CHIP DEVICE

(71) Applicant: QUALCOMM Incorporated, San Diego, CA (US)

(72) Inventors: Thomas Zeng, San Diego, CA (US); Azzedine Touzni, Carlsbad, CA (US)

(21) Appl. No.: 15/340,895

(22) Filed: Nov. 1, 2016

(51) Int. Cl. G06F 3/06; G06F 12/1027

(52) U.S. Cl. CPC G06F 3/0637; G06F 3/0622; G06F 3/0659; G06F 2212/68; G06F 12/1027; G06F 2212/50; G06F 3/0679

(57) ABSTRACT

In an aspect, an apparatus obtains, at one or more hardware configuration interfaces, a physical page number associated with a secure resource, a domain identifier, and at least one memory attribute. The one or more hardware configuration interfaces may be in communication with a resource protection unit that manages access to the secure resource. The apparatus configures, by the one or more hardware configuration interfaces, a page table entry in a page table maintained at the resource protection unit, where the page table entry is configured to include the physical page number associated with the secure resource, the domain identifier, and the at least one memory attribute. The resource protection unit processes a resource access transaction when an access permission for the resource access transaction is determined in the page table.

### FIELD OF THE DISCLOSURE

Aspects of the disclosure relate generally to managing a resource access control unit in a system-on-chip (SoC) device.

### BACKGROUND

In a system-on-chip device, master side resource access control hardware is typically managed by a memory management unit (or a system memory management unit), while the slave side resource access control hardware is generally programmed differently with a vendor specific mechanism that involves a variety of power management schemes and debug mechanisms. The slave side resource access control hardware typically implements one of various types of resource protection units. As such, when several of these different types of resource protection units are implemented, each type of protection unit may involve a different approach for programming the access control policies implemented by the resource protection units. For example, in order to program the various types of resource protection units with access control policies to be applied by the resource protection units, a user (e.g., a software developer or programmer) must become familiar with the specific manner in which each of the resource protection units is to be programmed. Moreover, such resource protection units typically require different power and clock configurations. These issues may introduce costly inefficiencies and/or a reduction in performance.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one aspect of the disclosure, a method for an apparatus is provided. The method may include obtaining, at one or more hardware configuration interfaces, a physical page number associated with a secure resource, a domain identifier, and at least one memory attribute, wherein the one or more hardware configuration interfaces is in communication with a resource protection unit that manages access to the secure resource. The method may further include configuring, by the one or more hardware configuration interfaces, a page table entry in a page table maintained at the resource protection unit, wherein the page table entry is configured to include the physical page number associated with the secure resource, the domain identifier, and the at least one memory attribute. The resource protection unit processes a resource access transaction when an access permission for the resource access transaction is determined in the page table.

In one aspect, the access permission for the resource access transaction is determined by obtaining, at the resource protection unit, the resource access transaction directed to the secure resource, the resource access transaction including at least the physical page number, determining the page table entry in the page table associated with the physical page number, and determining whether the page table entry indicates the access permission. In one aspect, the determination whether the page table entry indicates the access permission is based on the domain identifier and the at least one memory attribute associated with the physical page number.

In one aspect, the method may further include configuring, by the one or more hardware configuration interfaces, the resource protection unit and at least one additional resource protection unit with the same power management scheme or the same clock management scheme, wherein the resource protection unit and the at least one additional resource protection unit are configured to protect different secure resources. In one aspect, the protection unit is a register protection unit, a memory protection unit, or an address protection unit. In one aspect, configuring the page table entry may include halting, at the resource protection unit, operation of a translation buffer unit configured as a resource access control filter, updating one or more translation lookaside buffers, and resuming the operation of the translation buffer unit. In an aspect, updating the one or more translation lookaside buffers includes writing to a software interrupt register, or implementing a command que that is configured to update the translation lookaside buffers. In an aspect, the one or more hardware configuration interfaces comprises a single hardware configuration interface capable of managing the secure resource and other secure resources. In an aspect, the one or more hardware configuration interfaces comprises at least a first hardware configuration interface capable of managing the secure resource and other secure resources, and a second hardware configuration interface capable of managing the secure resource and the other secure resources. In an aspect, the first hardware configuration interface is controlled by a first subsystem and the second hardware configuration interface is controlled by a second subsystem.

In an aspect, an apparatus is provided. The apparatus may include a secure hardware resource, and a processing circuit coupled to the secure hardware resource. The processing circuit may be configured to obtain, at one or more hardware configuration interfaces, a physical page number associated with a secure resource, a domain identifier, and at least one memory attribute, wherein the one or more hardware configuration interfaces is in communication with a resource protection unit that manages access to the secure resource. The processing circuit may further be configured to configure, by the one or more hardware configuration interfaces, a page table entry in a page table maintained at the resource protection unit, wherein the page table entry is configured to include the physical page number associated with the secure resource, the domain identifier, and the at least one memory attribute. The resource protection unit may process a resource access transaction when an access permission for the resource access transaction is determined in the page table.

In one aspect, the resource protection unit is configured to obtain, at the resource protection unit, a resource access transaction directed to the secure resource, the resource access transaction including at least the physical page number, determine the page table entry in the page table associated with the physical page number, and determine whether the page table entry indicates the access permission. In an aspect, the processing circuit is further configured to configure, by the one or more hardware configuration interfaces, the resource protection unit and at least one additional resource protection unit with the same power management scheme or the same clock management scheme, wherein the resource protection unit and the at least one additional resource protection unit are configured to protect different secure resources. In an aspect, the processing circuit configured to configure the page table entry is further configured to halt, at the resource protection unit, an operation of a translation buffer unit configured as a resource access control filter, update one or more translation lookaside buffers, and resume the operation of the translation buffer unit.

In one aspect of the disclosure, an apparatus is provided. The apparatus may include means for obtaining, at one or more hardware configuration interfaces, a physical page number associated with a secure resource, a domain identifier, and at least one memory attribute, wherein the one or more hardware configuration interfaces is in communication with a resource protection unit that manages access to the secure resource. The apparatus may further include means for configuring, by the one or more hardware configuration interfaces, a page table entry in a page table maintained at the resource protection unit, wherein the page table entry is configured to include the physical page number associated with the secure resource, the domain identifier, and the at least one memory attribute. The resource protection unit processes a resource access transaction when an access permission for the resource access transaction is determined in the page table.

In one aspect, the access permission for the resource access transaction is determined by implementing means for obtaining, at the resource protection unit, the resource access transaction directed to the secure resource, the resource access transaction including at least the physical page number, means for determining the page table entry in the page table associated with the physical page number, and means for determining whether the page table entry indicates the access permission. In one aspect, the determination whether the page table entry indicates the access permission is based on the domain identifier and the at least one memory attribute associated with the physical page number.

In one aspect, the apparatus may further include means for configuring, by the one or more hardware configuration interfaces, the resource protection unit and at least one additional resource protection unit with the same power management scheme or the same clock management scheme, wherein the resource protection unit and the at least one additional resource protection unit are configured to protect different secure resources. In one aspect, the protection unit is a register protection unit, a memory protection unit, or an address protection unit. In one aspect, the means for configuring the page table entry may be configured to halt, at the resource protection unit, operation of a translation buffer unit configured as a resource access control filter, update one or more translation lookaside buffers, and resume the operation of the translation buffer unit. In an aspect, updating the one or more translation lookaside buffers includes writing to a software interrupt register, or implementing a command que that is configured to update the translation lookaside buffers. In an aspect, the one or more hardware configuration interfaces comprises a single hardware configuration interface capable of managing the secure resource and other secure resources. In an aspect, the one or more hardware configuration interfaces comprises at least a first hardware configuration interface capable of managing the secure resource and other secure resources, and a second hardware configuration interface capable of managing the secure resource and the other secure resources. In an aspect, the first hardware configuration interface is controlled by a first subsystem and the second hardware configuration interface is controlled by a second subsystem.

In an aspect, a method for an apparatus is provided. The method may include obtaining, at a memory management unit, a resource access transaction, and determining, at the memory management unit, whether to allow or reject the resource access transaction based on a first set of access control attributes associated with non-secure hardware resources when the resource access transaction is directed to the non-secure hardware resources, and a second set of access control attributes associated with secure hardware resources when the resource access transaction is directed to the secure hardware resources. The method may further include processing the resource access transaction based on the determination.

In an aspect, the method may further include maintaining a page table that includes a number of page table entries, wherein a first page table entry includes the first set of access control attributes and a second page table includes the second set of access control attributes. In an aspect, the method may further include obtaining, at the memory management unit, the first set of access control attributes associated with the non-secure hardware resources and the second set of access control attributes associated with the secure hardware resources from one or more hardware configuration interfaces. In an aspect, the non-secure hardware resources may include a first memory region in a memory device and the secure hardware resources may include a second region in the memory device. In an aspect, the method may further include configuring, at the memory management unit, a size of the second region of the memory device. In an aspect, the memory management unit may be a system memory management unit, and the obtained resource access transaction may be generated from a device external to a central processing unit. In an aspect, the device external to a central processing unit may be authorized to access the secure hardware resources. In an aspect, the resource access transaction includes a domain identifier indicating secure domain or a non-secure domain.

In an aspect, an apparatus is provided. The apparatus may include a secure hardware resource and a non-secure hardware resource, and a processing circuit coupled to the secure hardware resource and the non-secure hardware resource. The processing circuit may be configured to obtain, at the memory management unit, a resource access transaction, determine whether to allow or reject the resource access transaction based on a first set of access control attributes associated with the non-secure hardware resources when the resource access transaction is directed to the non-secure hardware resources, and a second set of access control attributes associated with the secure hardware resources when the resource access transaction is directed to the secure hardware resources. In an aspect, the processing circuit may process the resource access transaction based on the determination.

In an aspect, the processing circuit may be further configured to maintain a page table that includes a number of page table entries, wherein a first page table entry includes the first set of access control attributes and a second page table includes the second set of access control attributes. In an aspect, the processing circuit may be further configured to obtain, at the memory management unit, the first set of access control attributes associated with the non-secure hardware resource and the second set of access control attributes associated with the secure hardware resource from one or more hardware configuration interfaces. In an aspect, the non-secure hardware resource includes a first memory region in a memory device and the secure hardware resource includes a second region in the memory device. In an aspect, the processing circuit may be further configured to configure a size of the second region of the memory device. In an aspect, the memory management unit may be a system memory management unit, and the obtained resource access transaction may be generated from a device external to a central processing unit. In an aspect, the device external to a central processing unit may be authorized to access the secure hardware resource. In an aspect, the resource access transaction may include a domain identifier indicating secure domain or a non-secure domain.

In an aspect, an apparatus is provided. The apparatus may include means for obtaining, at a memory management unit, a resource access transaction, and means for determining, at the memory management unit, whether to allow or reject the resource access transaction based on a first set of access control attributes associated with non-secure hardware resources when the resource access transaction is directed to the non-secure hardware resources, and a second set of access control attributes associated with secure hardware resources when the resource access transaction is directed to the secure hardware resources. The apparatus may further include means for processing the resource access transaction based on the determination.

In an aspect, the apparatus may further include means for maintaining a page table that includes a number of page table entries, wherein a first page table entry includes the first set of access control attributes and a second page table includes the second set of access control attributes. In an aspect, the apparatus may further include means for obtaining, at the memory management unit, the first set of access control attributes associated with the non-secure hardware resources and the second set of access control attributes associated with the secure hardware resources from one or more hardware configuration interfaces. In an aspect, the non-secure hardware resources may include a first memory region in a memory device and the secure hardware resources may include a second region in the memory device. In an aspect, the apparatus may further include means for configuring, at the memory management unit, a size of the second region of the memory device. In an aspect, the memory management unit may be a system memory management unit, and the obtained resource access transaction may be generated from a device external to a central processing unit. In an aspect, the device external to a central processing unit may be authorized to access the secure hardware resources. In an aspect, the resource access transaction includes a domain identifier indicating secure domain or a non-secure domain.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates a block diagram of an example integrated circuit.

FIG. 2 illustrates a block diagram of an example access control hardware architecture.

FIG. 3 illustrates a block diagram of an example access control hardware architecture in accordance with various aspects of the disclosure.

FIG. 4 is a block diagram illustrating peripheral virtual machines as access control domains in an integrated circuit.

FIG. 5 is a block diagram illustrating system memory management unit (SMMU) based transaction flows in an access control hardware architecture in accordance with various aspects of the disclosure.

FIG. 6 is a block diagram illustrating a programming front end that provides an interface for configuring bus transaction attributes and/or firewall attributes in accordance with various aspects of the disclosure.

FIG. 7 is a block diagram illustrating an access control boot flow in accordance with various aspects of the disclosure.

FIG. 8 is a diagram illustrating address map changes in accordance with various aspects of the disclosure.

FIG. 9 is a diagram illustrating a register structure of an access control slot configuration register in accordance with various aspects of the disclosure.

FIG. 10 is block diagram illustrating select components of an apparatus according to at least one example of the disclosure.

FIG. 11 is a flowchart illustrating a method in accordance with various aspects of the present disclosure.

FIG. 12 is block diagram illustrating select components of an apparatus according to at least one example of the disclosure.

FIG. 13 is a flowchart illustrating a method in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

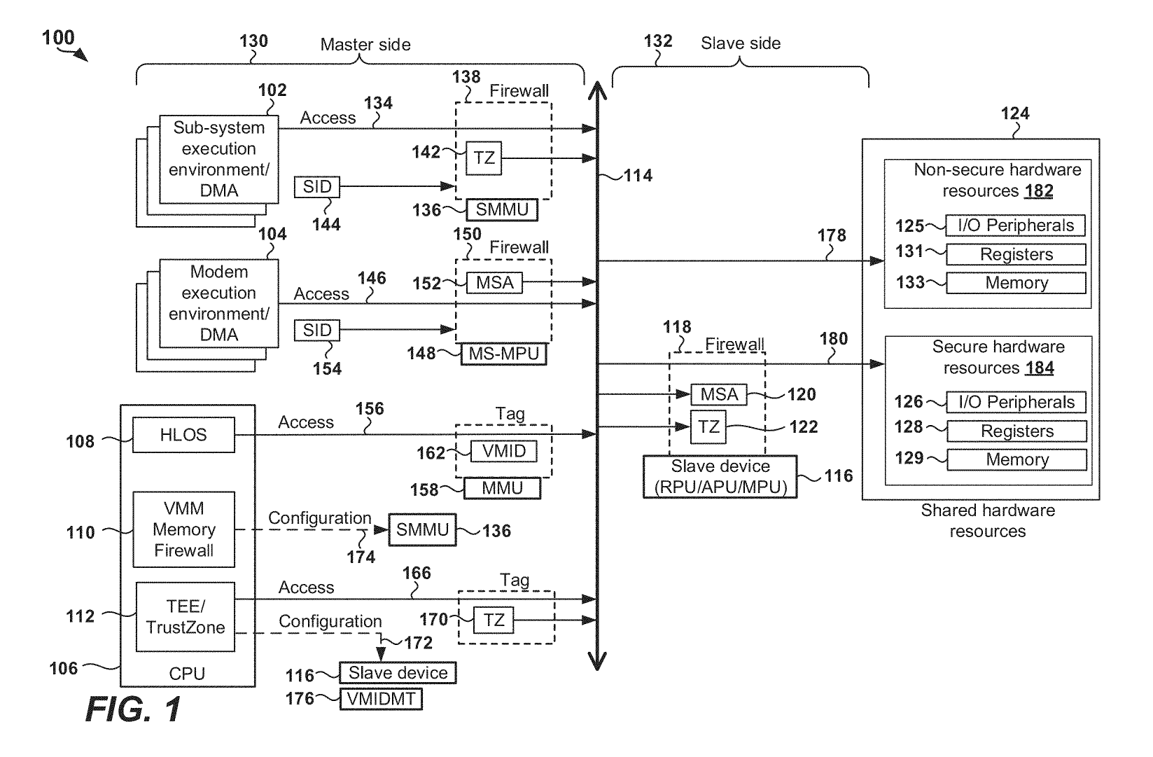

FIG. 1 illustrates a block diagram of an example integrated circuit 100. The integrated circuit 100 may be implemented in a system-on-chip (SoC) device. As shown in FIG. 1, the integrated circuit 100 may include shared hardware resources 124 that may be accessed by one or more master devices through a system bus 114. For example, the shared hardware resources 124 may include secure hardware resources 184, such as the input/output peripherals 126, the registers 128, and/or the memory 129. The memory 129 may be one or more memory regions (e.g., addresses) in a volatile or non-volatile memory device, where such one or more memory regions are configured (e.g., reserved) for secure memory transactions. The shared hardware resources 124 may also include non-secure hardware resources 182, such as the input/output peripherals 125, the registers 131 and/or the memory 133. The memory 133 may be one or more memory regions (e.g., addresses) in a volatile or non-volatile memory device, where such one or more memory regions are configured (e.g., reserved) for non-secure memory transactions.

As further shown in FIG. 1, the master devices in the integrated circuit 100 may include the central processing unit (CPU) 106 and devices external to the CPU 106. For example, the devices external to the CPU 106 may include execution environments having direct memory access (DMA) capability, such as the sub-system execution environment 102 and/or the modem execution environment 104. As shown in FIG. 1, the master devices in the integrated circuit 100 may be configured on the master side 130 of the system bus 114. One or more slave devices, such as the slave device 116, may be implemented on the slave side 132 of the system bus 114. For example, the slave device 116 may include a register protection unit (RPU), an address protection unit (APU), and/or a memory protection unit (MPU). The slave device 116 may implement a firewall 118 that is configured to receive memory transactions initiated from a master device (e.g., the CPU 106 and/or the execution environments 102,104) and to allow or deny the memory transactions based on one or more attributes (e.g., memory attributes) in order to maintain the security of the secure hardware resources 184.

The CPU 106 may have multiple execution environments, such that the CPU 106 may operate in any one of the multiple execution environments at a given time. In other words, the CPU 106 may not be able to operate simultaneously in two or more execution environments. For example, the multiple execution environments may include a non-secure execution environment (also referred to as a non-secure domain) and a trusted execution environment (also referred to as a secure domain or a TrustZone®). For example, the CPU 106 may execute non-secure instructions (also referred to as non-secure software or non-secure code) while operating in the non-secure execution environment and may switch to the trusted execution environment (TEE) to execute secure instructions (also referred to as secure software or secure code). The CPU 106 may include a high level operating system (HLOS) 108, a virtual machine manager (VMM) memory firewall device 110, and a trusted executed environment 112. In one example, the HLOS 108 may be a host operating system or a guest operating system running on a virtual machine (VM). It should be understood that the CPU 106 may support multiple guest operating systems (e.g., Windows™ or Linux™) running on multiple virtual machines. For example, the CPU 106 may be operating in a non-secure execution environment when executing non-secure instructions associated with the HLOS 108. The CPU 106 may leave the non-secure execution environment and enter the trusted execution environment 112 when secure instructions are to be executed.

The CPU 106 may implement a memory management unit (MMU) 158 that manages memory for applications running on the HLOS 108. The HLOS 108 may support a stage of virtual memory management to enable partitioning of the memory space in the physical memory (e.g., the memory 133) across multiple processes and applications. Accordingly, in one example, the MMU 158 may be configured to perform a stage of memory address translation to convert a virtual address (VA) to a physical address (PA). When the CPU 106 is implementing multiple guest operating systems, however, the memory that is being allocated by each guest operating system is not the true physical memory of the system. Instead, the memory that is being allocated by each guest operating system is an intermediate physical memory. Accordingly, in one example, the MMU 158 may be configured to perform two stages of memory address translation. For example, a first stage of memory address translation may convert a virtual address to an intermediate physical address (IPA), and a second stage of memory address translation may convert the intermediate physical address to a physical address. The VMM memory firewall 110 (also referred to as a hypervisor (HYP) device) may control the second stage of address translation by configuring the relationships between the intermediate physical addresses and their corresponding physical addresses. This two-stage approach maintains the integrity of the system by providing isolation in a shared memory space and preventing different guest operating systems from accessing the same regions of the physical memory.

As shown in FIG. 1, the HLOS 108 may initiate a resource access transaction 156 when the CPU 106 is operating in a non-secure execution environment. The term resource access transaction as used herein may refer to a read operation, a write operation, an execution of an instruction, or other such operation with respect to a hardware resource (e.g., a memory device). The resource access transaction 156 may include a unique virtual machine identifier (VMID) associated with the HLOS 108. The MMU 158 may compare the VMID in the resource access transaction 156 to a VMID 162 included in a cache tag at the MMU 158 to determine whether the HLOS 108 is permitted to access the requested region of the non-secure hardware resources 182. For example, if the VMID in the resource access transaction 156 does not match the VMID 162, the MMU 158 may deny the resource access transaction 156. In one example, the resource access transaction 156 may be provided to the system bus 114 and may be transmitted to the non-secure hardware resources 182 as the signal 178.

As further shown in FIG. 1, when the CPU 106 is operating in a secure execution environment (e.g., when the trusted execution environment 112 is executing secure instructions), the trusted execution environment 112 may initiate a resource access transaction 166. It should be noted that access to the secure hardware resources 184 in the shared hardware resources 124 are managed by the slave device 116. The slave device 116 may be configured as a protection unit, such as a memory protection unit (MPU), a register protection unit (RPU), or an address protection unit, for managing access to a specific secure hardware resource in the secure hardware resources 184. For example, the slave device 116 may be an MPU that exclusively manages access to the memory 129, or an RPU that exclusively manages access to the registers 128. The resource access transaction 166 may include a unique tag (e.g., the TrustZone® (TZ) tag 170) which may be a value that indicates whether the resource access transaction 166 is an authorized secure transaction. In one example, the resource access transaction 166 and the TZ tag 170 may be provided to the system bus 114 and may be transmitted to the slave device 116. The slave device 116 may receive the resource access transaction 166 (shown as the signal 180 on the slave side 132) and the TZ tag 170 (shown as the TZ tag 122 on the slave side 132) and may determine whether the resource access transaction is authorized. For example, the slave device 116 may implement a firewall device 118 that determines whether the TZ tag 122 includes an authorized (e.g., recognized) value. If the TZ tag 122 includes an authorized value, the firewall device 118 may allow access to the requested secure hardware resources 184. The trusted execution environment 112 may configure the security attributes of the slave device 116 and/or a virtual machine identifier mapping table (VMIDMT) 176 through a configuration signal 172.

As shown in FIG. 1, the sub-system execution environment 102 may initiate a resource access transaction 134 independent of the CPU 106. The system memory management unit (SMMU) 136 may be configured to manage the non-secure hardware resources 182 and may be configured to perform a one-stage or two-stage address translation as previously described with respect to the MMU 158. Therefore, when the sub-system execution environment 102 attempts to access the non-secure hardware resources 182, the RAW 136 may convert (e.g., via a one-stage or two-stage address translation) a virtual address included in the resource access transaction 134 to a physical address before transmission to the non-secure hardware resources 182 over the system bus 114. The CPU 106 may configure the SMMU 136 via the configuration signal 174. For example, the VMM memory firewall 110 may appropriately manage the mapping of virtual addresses to physical addresses applied by the SMMU 136. The sub-system execution environment 102 may also provide a secure identifier (SID) 144 associated with the sub-system execution environment 102 to the SMMU 136.

When the sub-system execution environment 102 attempts to access the secure hardware resources 184, the security privileges of the CPU 106 may be transferred to the sub-system execution environment 102. Since the secure hardware resources 184 are managed by the slave device 116, and not by the SMMU 136, the resource access transaction 134 may be tagged by the firewall device 138 implemented by the SMMU 136 to include a unique identifier (e.g., the TrustZone® (TZ) tag 142) which may be a value that indicates whether the resource access transaction 134 is an authorized secure transaction. The slave device 116 may receive the resource access transaction 134 (e.g., shown as the signal 180 on the slave side 132) and the TZ tag 142. (e.g., shown as the TZ tag 122 on the slave side 132) and may determine whether the resource access transaction 134 is authorized.

As shown in FIG. 1, the modem execution environment 104 may initiate a resource access transaction 146 independent of the CPU 106 in a manner similar to the previously discussed sub-system execution environment 102. For example, in the case of the modem execution environment 104, the master side memory protection unit (MS.-MPU) 148 may be configured to manage the resource access transaction 146 based on a modem self-authentication (MSA) identifier 152 (e.g., which may be received as the MSA identifier 120 on the slave side 132).

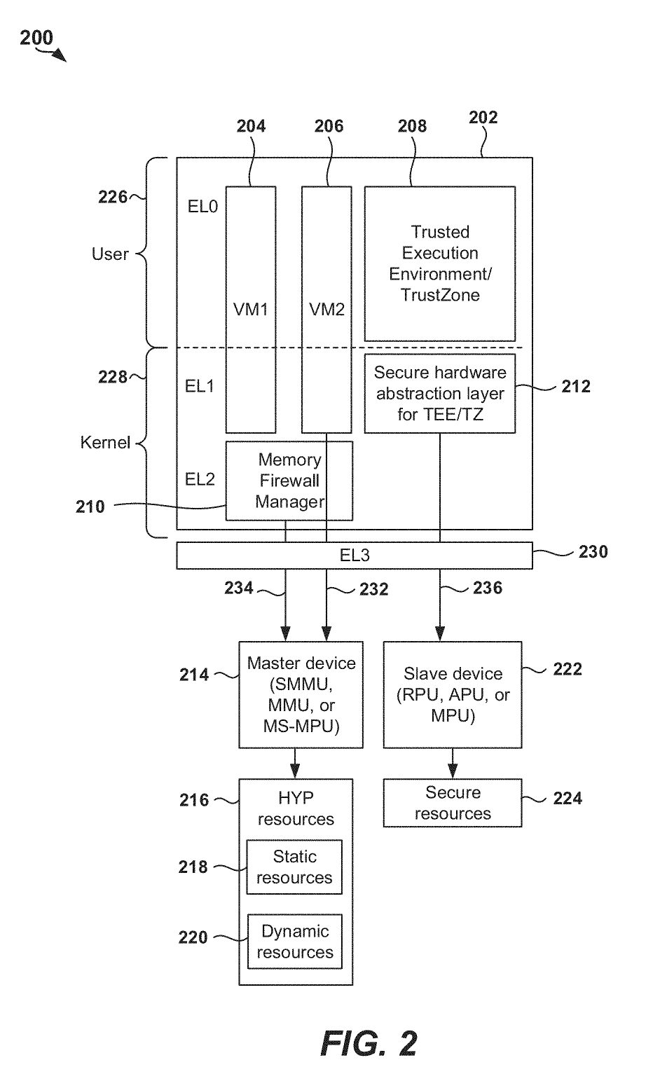

FIG. 2 illustrates a block diagram of an example access control hardware architecture 200. For example, the access control hardware architecture 200 may be implemented as an integrated circuit in a system-on-chip (SoC) device. The access control hardware architecture 200 may include a CPU 202, a master device 214 configured to manage non-secure resources, hypervisor resources 216, a slave device 222, and secure resources 224. The CPU 202 may include a first virtual machine (VM1) 204, a second virtual machine (VM2) 206, a memory firewall manager 210, and a secure hardware abstraction layer 212 for a trusted execution environment (also referred to as the TrustZone®).

The CPU 202 may operate in a non-secure execution environment or a trusted execution environment in a manner similar to the previously discussed CPU 106. For example, the CPU 202 may be operating in the non-secure execution environment when executing instructions associated with the first virtual machine 204 and/or the second virtual machine 206, or the CPU 202 may be operating in the trusted execution environment 208 when executing secure instructions (e.g., a secure boot instructions). The first virtual machine 204 may implement a first operating system (e.g., a Windows™ operating system) and the second virtual machine 206 may implement a second operating system (e.g., a Linux™ operating system). When the CPU 202 is operating in the non-secure execution environment, the first virtual machine 204 or the second virtual machine 206 may access non-secure shared hardware resources, such as the hypervisor resources 216. For example, the hypervisor resources 216 may include static resources 218 and/or dynamic resources 220 that are managed by the memory firewall manager 210 (also referred to as a hypervisor device). For example, the second virtual machine 206 may initiate a resource access transaction 232 to access the hypervisor resources 216. The resource access transaction 232 may be received by the master device 214. For example, the master device 214 may be an SMMU, an MMU, or an MS-MPU. The master device 214 may perform the appropriate address translation (e.g., a one-stage or two-stage address translation as previously discussed) of a virtual address in the resource access transaction 232 to a physical address. As shown in FIG. 2, when the master device 214 includes an SMMU, the memory manager firewall 210 may configure the SMMU via the configuration signal 234. For example, the memory firewall manager 210 may appropriately manage the mapping of virtual addresses to physical addresses applied by the SMMU.

When the CPU 202 is operating in the trusted execution environment 208, the CPU 202 may initiate a resource access transaction 236 to the slave device 222 via the secure hardware abstraction layer 212 in order to access the secure resources 224. For example, the slave device 222 may include a register protection unit (RPU), an address protection unit (APU), and/or a memory protection unit (MPU). The slave device 222 may implement a firewall that is configured to receive resource access transactions initiated from a master device (e.g., the CPU 202) and to allow or deny the resource access transactions based on one or more attributes (e.g., memory attributes) in order to maintain the security of the secure resources 224. It should be noted that access to the secure resources 224 is managed by the slave device 222. For example, the slave device 222 may be au MPU that exclusively manages access to a secure region of a shared memory device, or au RPU that exclusively manages access to a secure set of registers. The resource access transaction 236 may include a unique tag (e.g., the TrustZone® (TZ) tag) which may be a value that indicates whether the resource access transaction 236 is an authorized secure transaction. The slave device 222 may receive the resource access transaction 236 and may determine whether the resource access transaction 236 is authorized based on the unique tag (and/or other security attributes). For example, the slave device 222 may implement a firewall device that determines whether the unique tag includes an authorized (e.g., recognized) value. If the unique tag includes an authorized value, the firewall device may allow access to the secure resources 224. The trusted execution environment 208 may configure the security attributes of the slave device 222.

As shown in FIG. 2, the access control hardware architecture 200 may include exception levels (e.g., EL0 to EL3) representing software execution privileges, where EL0 is the least privileged and EL3 is the most privileged. As shown in FIG. 2, for example, EL0 corresponds to the user space 226, EL1 corresponds to the kernel 228, EL2 corresponds to the memory firewall manager 210, and EL3 corresponds to the trusted execution environment security monitor 230 (also referred to as a TrustZone® security monitor).

It should be noted that the slave device 222 is generally architected for a static environment where changes are not anticipated. Implementation of slave devices (e.g., the slave device 222) that serve as resource protection units independent of an SMMU (or MMU) may introduce inefficiencies and design complexity. For example, in order to program the various types of resource protection units with access control policies to be applied by the resource protection units, a user (e.g., a software developer or programmer) must become familiar with the specific manner in which each of the resource protection units is to be programmed. Moreover, such resource protection units typically require different power and clock configurations.

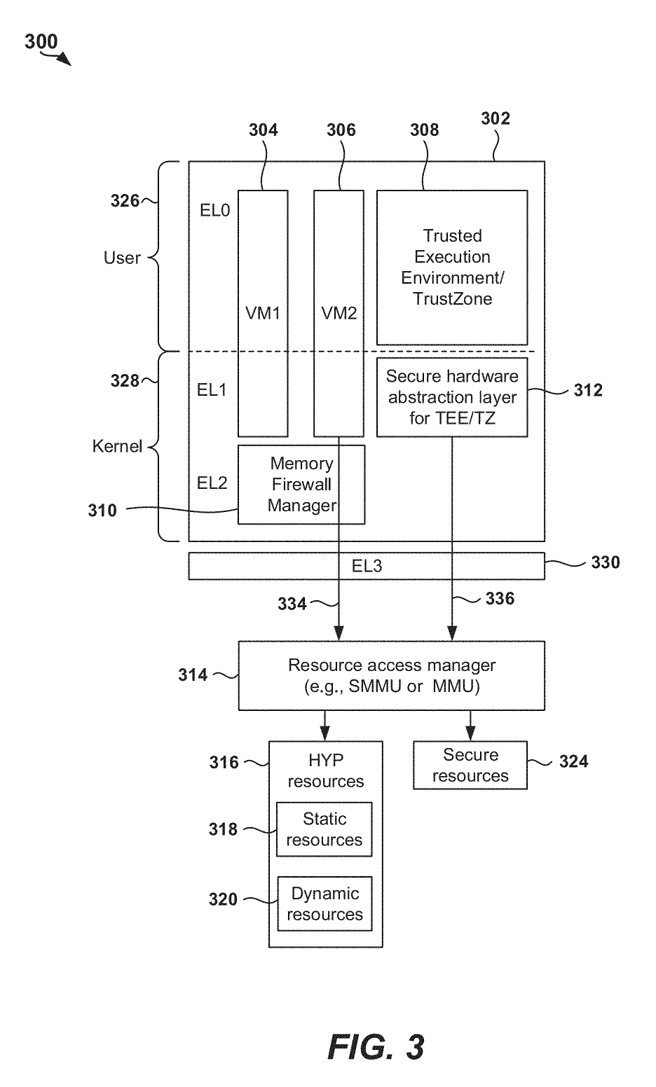

FIG. 3 illustrates a block diagram of an example access control hardware architecture 300 in accordance with various aspects of the disclosure. For example, the access control hardware architecture 300 may be implemented as au integrated circuit in a system-on-chip (SoC) device. In one aspect of the disclosure, the access control hardware architecture 300 may include a CPU 302, a resource access manager 314, hypervisor resources 316, and secure resources 324. The CPU 302 may further include a first virtual machine (VM1) 304, a second virtual machine (VM2) 306, a memory firewall manager 310, and a secure hardware abstraction layer 312 for a trusted execution environment (also referred to as the TrustZone®).

The CPU 302 may operate in a non-secure execution environment or a trusted execution environment in a manner similar to the previously discussed CPU 106. For example, the CPU 302 may be operating in the non-secure execution environment when executing instructions associated with the first virtual machine 304 and/or the second virtual machine 306, or the CPU 302 may be operating in the trusted execution environment 308 when executing secure instructions (e.g., secure boot instructions). For example, the first virtual machine 304 may implement a first operating system (e.g., a Windows™ operating system) and the second virtual machine 306 may implement a second operating system (e.g., a Linux™ operating system). When the CPU 302 is operating in the non-secure execution environment, the first virtual machine 304 or the second virtual machine 306 may access non-secure shared hardware resources, such as the hypervisor resources 316. For example, the hypervisor resources 316 may include static resources 318 and/or dynamic resources 320 that are managed by the memory firewall manager 310 (also referred to as a hypervisor device).

For example, the second virtual machine 306 may initiate a resource access transaction 334 to access the hypervisor resources 316. The resource access transaction 334 may be received by the resource access manager 314. For example, the resource access manager 314 may be an SMMU or an MMU. The resource access manager 314 may perform the appropriate address translation (e.g., a one-stage or two-stage address translation as previously discussed) of a virtual address in the resource access transaction 334 to a physical address. In an aspect, the memory firewall manager 310 may appropriately manage the mapping of virtual addresses to physical addresses applied by the SMMU resource access manager 314.

When the CPU 302 is operating in the trusted execution environment 308, the CPU 302 may initiate a resource access transaction 336 to the resource access manager 314 via the secure hardware abstraction layer 312 in order to access the secure resources 324. The resource access manager 314 may implement a firewall that is configured to receive resource access transactions and to allow or deny the resource access transactions based on one or more attributes in order to maintain the security of the secure resources 324. It should be understood that in the aspect of FIG. 3, access to the hypervisor resources 316 (e.g., non-secure resources) and the secure resources 324 is managed by the resource access manager 314. Therefore, and in contrast to the access control hardware architecture 200, the aspect of FIG. 3 avoids the use of a slave device (e.g., a protection unit, such as an MPU, APU, and/or RPU) independent of an SMMU or MMU for managing access to the secure resources 324. Accordingly, the resource access manager 314 may receive the resource access transaction 336 and may determine whether the resource access transaction 336 is authorized based on security attributes (e.g., a domain ID and/or privileged memory attributes) assigned to the secure resources 324. For example, the resource access manager 314 may implement a firewall device that determines whether domain ID includes an authorized (e.g., recognized) value. If the domain ID includes an authorized value, the firewall device may allow access to the secure resources 324. In an aspect, the trusted execution environment 308 may configure the security attributes of the resource access manager 314.

As shown in FIG. 3, the access control hardware architecture 300 may include exception levels (e.g., EL0 to EL3) representing software execution privileges, where EL0 is the least privileged and EL3 is the most privileged. As shown in FIG. 3, for example, EL0 corresponds to the user space 326, EL1 corresponds to the kernel 328, EL2 corresponds to the memory firewall manager 310, and EL3 corresponds to the trusted execution environment security monitor 330 (also referred to as a TrustZone® security monitor).

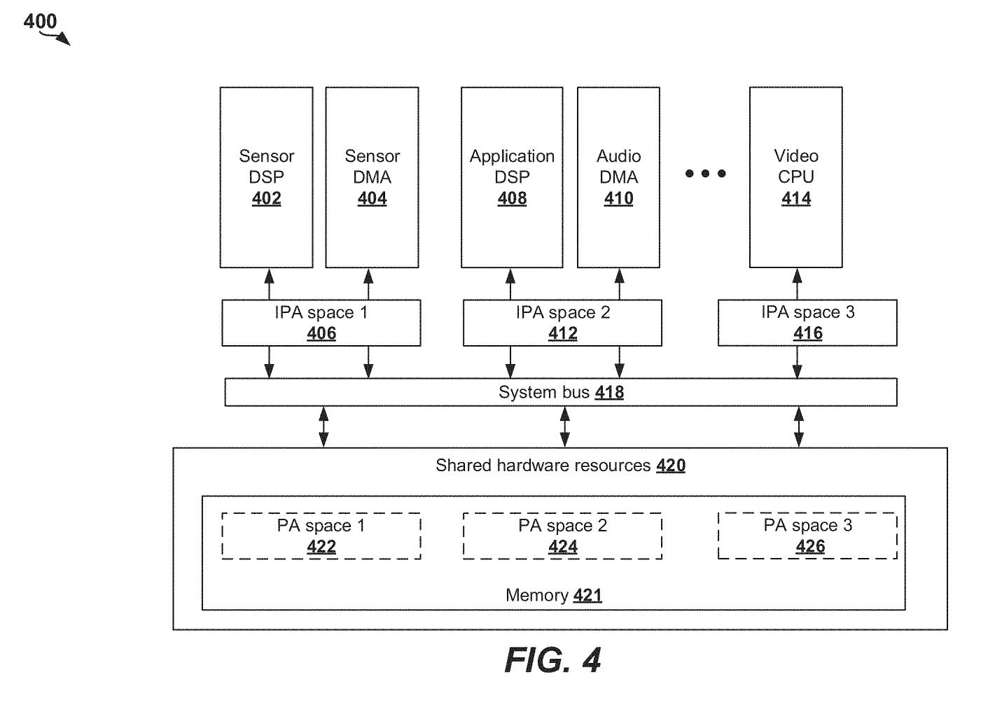

FIG. 4 is a block diagram illustrating peripheral virtual machines as access control domains in an integrated circuit 400. As shown in FIG. 4, the integrated circuit 400 may include a sensor digital signal processor (DSP) 402, a sensor direct memory access (DMA) controller 404, an application digital signal processor (DSP) 408, an audio direct memory access (DMA) controller 410, and a video CPU 414. It should be understood that the integrated circuit 400 serves as one example and that in other aspects, the integrated circuit 400 may include a different number of I/O devices and/or different types of I/O devices than shown in FIG. 4. The integrated circuit 400 may further include a system bus 418 coupled to the shared hardware resources 420. In an aspect, the shared hardware resources 420 may include a memory device and/or one or more input/output (I/O) devices.

The sensor DSP 402 may be assigned to a first virtual machine, the application DSP 408 may be assigned to a second virtual machine, and a video firewall for the video CPU 414 may be assigned to a third virtual machine. Each virtual machine (e.g., each of the first, second, and third virtual machines) may be assigned a unique intermediate physical address (IPA) space that is mapped to a corresponding region of the shared hardware resources 420 (e.g., a memory or a memory mapped device) represented by a physical address (PA) space. Furthermore, a virtual machine may allocate its corresponding unique intermediate physical address (IPA) space as a virtual address (VA) space to a process (e.g., application or software) supported by the virtual machine. Therefore, the virtual address space may be considered to be an abstraction of the intermediate physical address space, and the intermediate physical address space may be considered to be an abstraction of the physical address space. For example, and as shown in FIG. 4, the first virtual machine (e.g., associated with the sensor DSP 402) may be allocated a first intermediate physical address space 406 which is mapped to the first physical address space 422 in the memory 421, the second virtual machine (e.g., associated with the application DSP 408) may be allocated a second intermediate physical address space 412 which is mapped to the second physical address space 424 in the memory 421, and the third virtual machine associated with the video firewall for the video CPU 414) may be allocated a third intermediate physical address space 416 which is mapped to the third physical address space 426 in the memory 421. Since each virtual machine is allocated a unique intermediate physical address space, each virtual machine and its corresponding intermediate physical address space may define an access control domain. Accordingly, one virtual machine may not access (e.g., read data from or write data to) the particular resources in the shared hardware resources 420 assigned to another virtual machine.

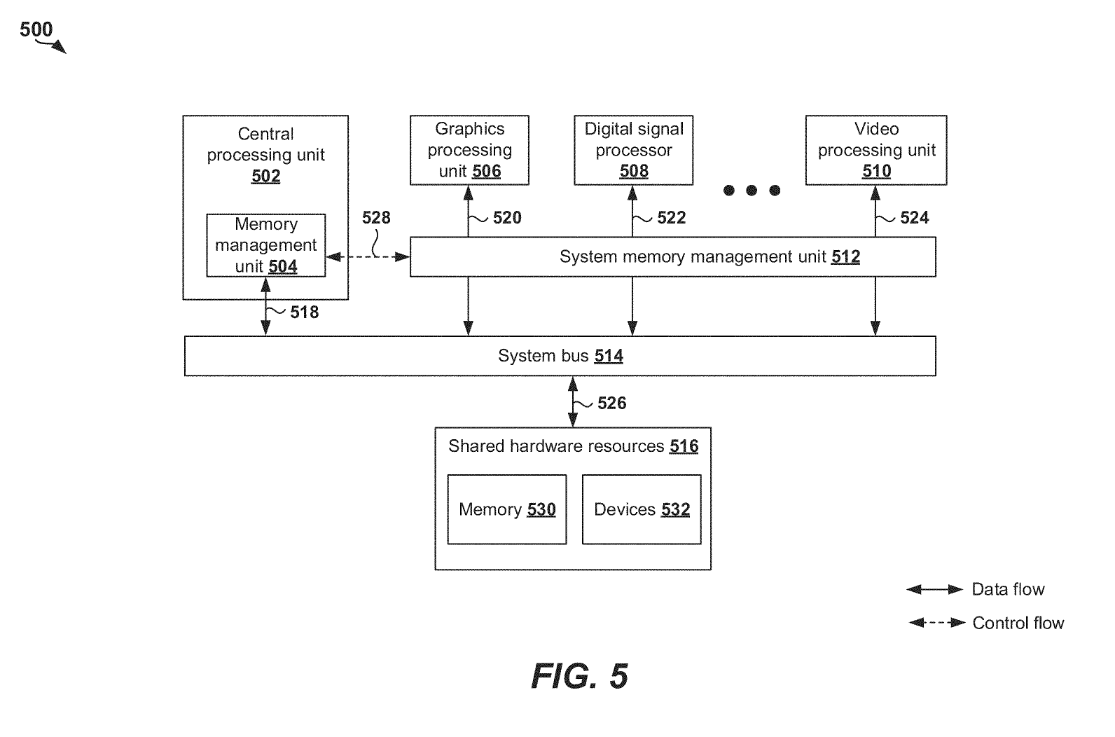

FIG. 5 is a block diagram illustrating SMMU based transaction flows in an access control hardware architecture 500 in accordance with various aspects of the disclosure. The access control hardware architecture 500 may include a CPU 502 and a number of input/output (I/O) devices, such as a graphics processing unit 506, a digital signal processor 508, and/or a video processing unit 510. It should be understood that the access control hardware architecture 500 serves as one example and that in other aspects, the access control hardware architecture 500 may include a different number of I/O devices and/or different types of I/O devices than shown in FIG. 5. The access control hardware architecture 500 may further include an SMMU 512, a system bus 514, and shared hardware resources 516. In an aspect, the shared hardware resources 516 may include a memory 530 and one or more memory mapped devices 532.

In an aspect, the CPU 502 may implement a number of virtual machines, and the graphics processing unit 506, the digital signal processor 508, and the video processing unit may each be assigned to a different virtual machine. Each virtual machine may be assigned a unique intermediate physical address (IPA) space that is mapped to a corresponding region of the shared hardware resources 516 (e.g., the memory 530 or the memory mapped devices 532) represented by a physical address (PA) space. Furthermore, a virtual machine may allocate its corresponding unique intermediate physical address (IPA space as a virtual address (VA) space to a process (e.g., application or software) supported by the virtual machine. Therefore, each virtual machine and its corresponding IPA space may define a different access control domain. Accordingly, one virtual machine may not access (e.g., read data from or write data to) the particular resources in the shared hardware resources 516 assigned to another virtual machine.

In the aspect of FIG. 5, the SMMU 512 may present the previously discussed intermediate physical address spaces assigned to each virtual machine to the corresponding devices. For example, the SMMU 512 may provide a first intermediate physical address space to the graphics processing unit 506, a second intermediate physical address space to the digital signal processor 508, and a third intermediate physical address space to the video processing unit 510. The SMMU 512 may be configured by the MMU 504 via the control signals 52, which can provide the relationships between the devices and the intermediate physical address spaces, as well as the appropriate mapping between the intermediate physical address spaces and the physical address spaces in the shared hardware resources 516. Accordingly, the addresses in the data flows 520, 522, and 524 between the devices and the system bus 514 may be appropriately translated from intermediate physical addresses to physical addresses. Each data flow may then be routed by the system bus 514 to the shared resources 516 through the data flow 526. Therefore, the devices (e.g., the graphics processing unit 506, the digital signal processor 508, and/or the video processing unit 510) may initiate resource access transactions with respect to the shared resources 516 independent of the CPU 502. The MMU 504 may perform address translation for resource access transactions initiated by a virtual machine implemented at the CPU 502 and may transmit the resource access transactions to the system bus 514 through the data flow 518.

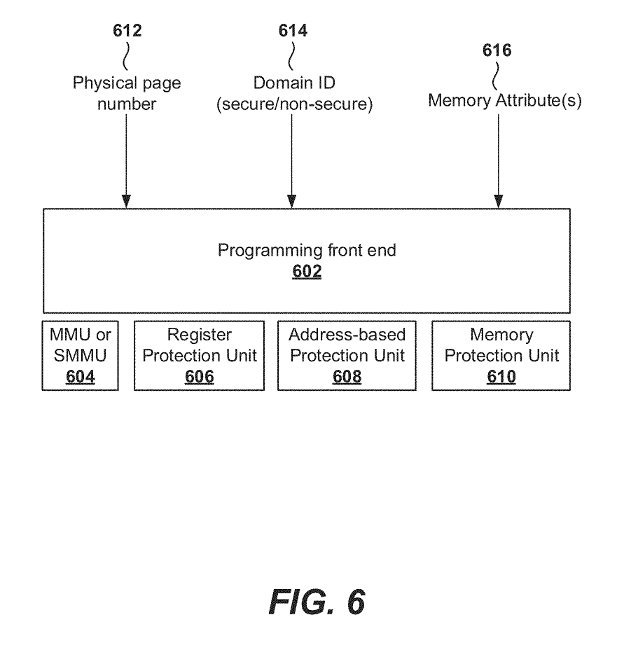

FIG. 6 is a block diagram illustrating a programming front end 602 that provides an interface for configuring bus transaction attributes and/or firewall attributes in accordance with various aspects of the disclosure. In an aspect, the programming front end 602 may enable a user to configure attributes used by an MMU 604 (or SMMU), and/or firewalls implemented by slave devices managing secure hardware resources. For example, the slave devices may be protection units, such as the register protection unit (RPU) 606, the address protection unit (APU) 608, and/or the memory protection unit (MPU) 610. In au aspect, a user may provide attributes (e.g., security attributes associated with resource access transactions) such as a physical page number 612, a domain ID 614, and or a memory attribute(s) 616. For example, the domain ID 614 may be an eight-bit value that indicates a secure domain or a non-secure domain. The programming front end 602 may then program the appropriate attributes of the MMU 604 (or SMMU), and/or firewalls implemented by slave devices managing secure hardware resources. In an aspect, the programming front end 602 may also be used to manage power and clock configurations.

It can be appreciated that the programming front end 602 may significantly reduce the complexities typically introduced when a user attempts to configure attributes used by an MMU 604 (or SMMU), and/or firewalls implemented by slave devices managing secure hardware resources. For example, an integrated circuit may include a number of different slave devices (e.g., the RPU 606, the APU 608, and/or the MPU 610) controlling access to secure shared resources. In such example, access control policies applied by each of the slave devices (e.g., at a firewall of a slave device) may be programmed differently and, therefore, a user must become familiar with the specific manner in which each slave device is to be programmed. These issues may introduce costly inefficiencies and/or a reduction in performance. In the aspect of FIG. 6, however, a user may provide the appropriate attributes (e.g., a physical page number 612, a domain ID 614, and or a memory attribute(s) 616) to the programming front end 602, which may then appropriately configure the MMU or SMMU and the different types of slave devices with the appropriate attributes.

In an aspect, the programming front end 602 may manage one or more slave devices. In other aspects, a set of slave devices (e.g., secure resources) in a system may be managed by two or more programming front ends. In such other aspects, for example, a first programming front end capable of managing the set of slave devices may be controlled by a first subsystem and a second programming front end capable of managing the set of slave devices may be controlled by a second subsystem. For example, the term “managing” may refer to configuring or modifying access permissions for the set of slave devices as described herein. For example, the first subsystem may be controlled by a first CPU (e.g., the main processor of the system) and the second subsystem may be controlled by a second CPU (e.g., a processor, such as a digital signal processor (DSP), that is in communication with the main processor of the system). For example, the second programming front end may manage the set of slave devices when the first subsystem is in a power saving mode or low performance mode.

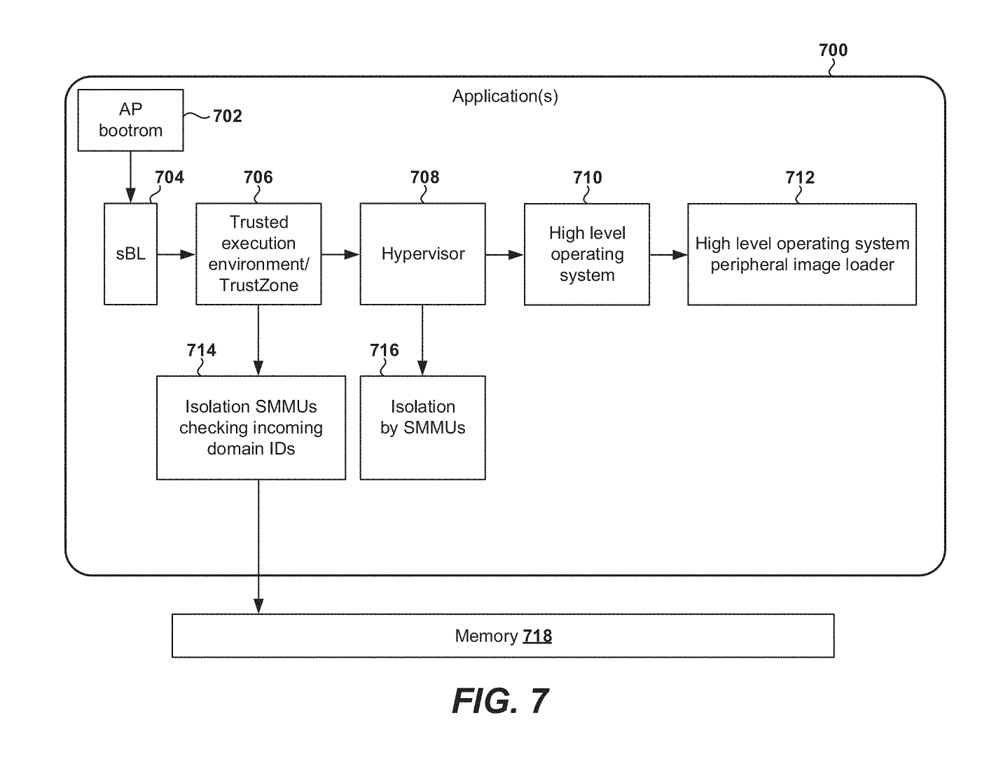

FIG. 7 is a block diagram illustrating an access control boot flow in accordance with various aspects of the disclosure. The access control boot flow may be performed by a CPU, such as the CPU 302 previously described with respect to FIG. 3. As shown in FIG. 7, the CPU may jump to the application processor (AP) bootrom 702, which may be a read-only memory for example. The CPU may then initiate the secondary boot loader (sBL) 704 and may proceed to load a trusted execution environment image 706. In some aspects, the term “application processor” as used herein may refer to a CPU (e.g., the main processor of the system) and any associated hardware co-processor units configured for multimedia processing.

The trusted execution environment image 706 may provide authorized domain IDs associated with the trusted execution environment to one or more SMMUs. The SMMUs may subsequently use the domain IDs to appropriately check 714 whether incoming domain IDs are authorized to access secure resources (e.g., designated secure regions of the memory 718). The hypervisor 708 may then assign intermediate physical address spaces to virtual machines running on the CPU to ensure isolation of resources (e.g., isolation of memory spaces) assigned to each virtual machine. As previously discussed, each intermediate physical address space may correspond to a physical address space (e.g., a physical address space in the memory 718). The high level operating system 710 may then initiate, and may proceed to allocate an assigned intermediate physical address space to one or more applications. Finally, the HLOS peripheral image loader 712 may be initiated,

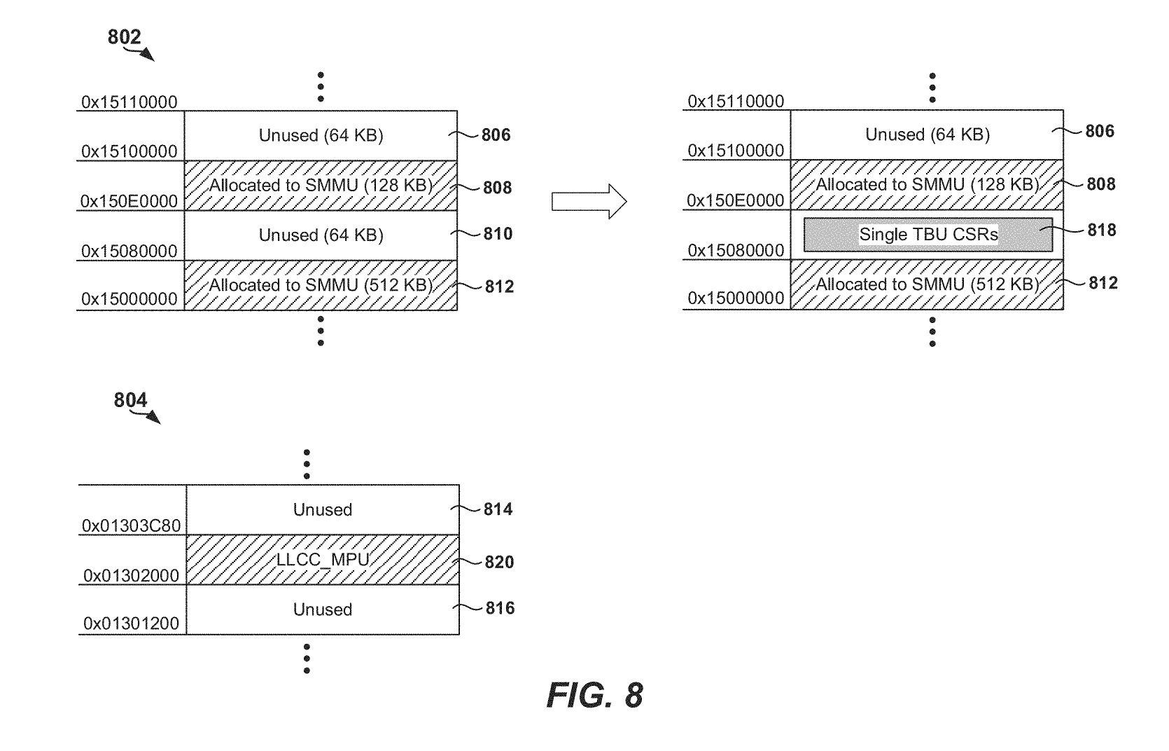

FIG. 8 is a diagram illustrating address map changes in accordance with various aspects of the disclosure. In one example, a CPU (e.g., the CPU 302 in FIG. 3) may determine available memory slots, such as the unused memory slots 806 and 810, between previously allocated memory slots 808, 812 containing memory access attributes (e.g., information for permitting or denying resource access transactions at an MMU) in a first memory portion 802. As shown in FIG. 8, the CPU may insert one or more single translation buffer unit (TBU) control status registers (CSRs) that contain new memory access attributes in the unused memory slots, such as the single TBU CSRs 818 inserted in the unused memory slot 810. As further shown in FIG. 8, the CPU may update single translation lookaside buffers (TLBs) by writing to the software interrupt (SWI) registers 804, such as the SWI register 820 between the unused memory spaces 814, 816.

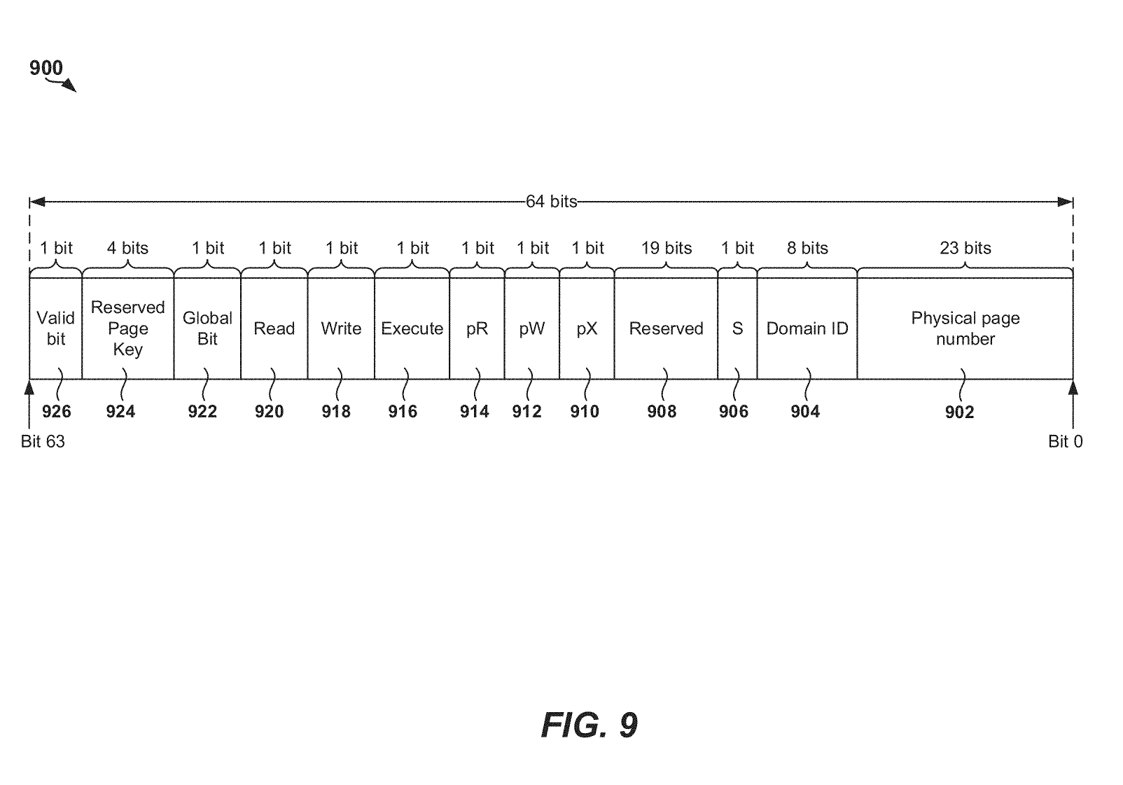

FIG. 9 is a diagram illustrating a register structure 900 of an access control slot configuration register in accordance with various aspects of the disclosure. For example, the register structure 900 may be 64 bits in length. In other examples, the length of the register structure 900 may be greater than or less than 64 bits. As shown in FIG. 9, the register structure 900 may include a physical page number 902. In an aspect, the physical page number 902 may be the physical page number of the starting address of a memory resource. A physical address field may map the lower 36-bit space (e.g., 64 GB). For example, the physical page number 902 may be 23 bits. The register structure 900 may further include a domain identifier (ID) 904. For example, the domain ID 904 may be 8 bits in length. The register structure 900 may further include a size “S” bit 906. The size bit 906, together with the least significant bits of the physical page number (PPN) 902, may be used to determine the memory page size as shown in Table 1 below. In some aspects, pages with S=0 and a least-significant PPN other than those listed in Table 1 below may result in undefined behavior.

TABLE 1

| Size bit and physical page number values | Page size | |
|---|---|---|
| S = 1 | 4 | KB |
| S = 0 and PPN[0] = 1 | 16 | KB |
| S = 0 and PPN[1:0] = 10 | 64 | KB |
| S = 0 and PPN[2:0] = 100 | 256 | KB |
| S = 0 and PPN[3:0] = 1000 | 1 | MB |
| S = 0 and PPN[4:0] = 10000 | 4 | MB |
| S = 0 and PPN[5:0] = 100000 | 16 | MB |
| S = 0 and PPN[6:0] = 1000000 | 64 | MB |
| S = 0 and PPN[7:0] = 10000000 | 256 | MB |
| S = 0 and PPN[8:0] = 100000000 | 1 | GB |

The register structure 900 may further include a reserved set of bits 908. For example, the reserved set of bits 908 may be 19 bits. The register structure 900 may further include an execute privileged access permission bit 910, a write privileged access permission bit 912, and a read privileged access permission bit 914. The register structure 900 may further include an execute non-privileged access permission bit 916, a write non-privileged access permission bit 918, and a read non-privileged access permission bit 920. The register structure 900 may further include a global bit 922. In an aspect, when the global bit 922 is set (e.g., set to logic ‘1’), the domain ID 904 may be ignored. The register structure 900 may further include a reserved page key 924, which may include a reserved set of bits for a page-based hardware architecture key (e.g., a cryptographic key). The register structure 900 may further include a valid bit 926, which may indicate whether or not the entry (e.g., the values in the register structure 900) should used for matching. The valid bit 926 may be cleared on reset for all translation lookaside buffer (TLB) entries.

In an aspect, an access control slot may be programmed by first halting the operation of a translation buffer unit serving as a resource access control filter. If the client of the resource access control filter has cache structures, they may be eliminated with software. The single translation lookaside buffers (TLBs) may be updated by writing to one or more software interrupt (SWI) registers as discussed above with respect to FIG. 8. In one aspect, a command que may be implemented to update the TLBs. The operation of the translation buffer unit (TBU) may be resumed.

### First Exemplary Device and Method

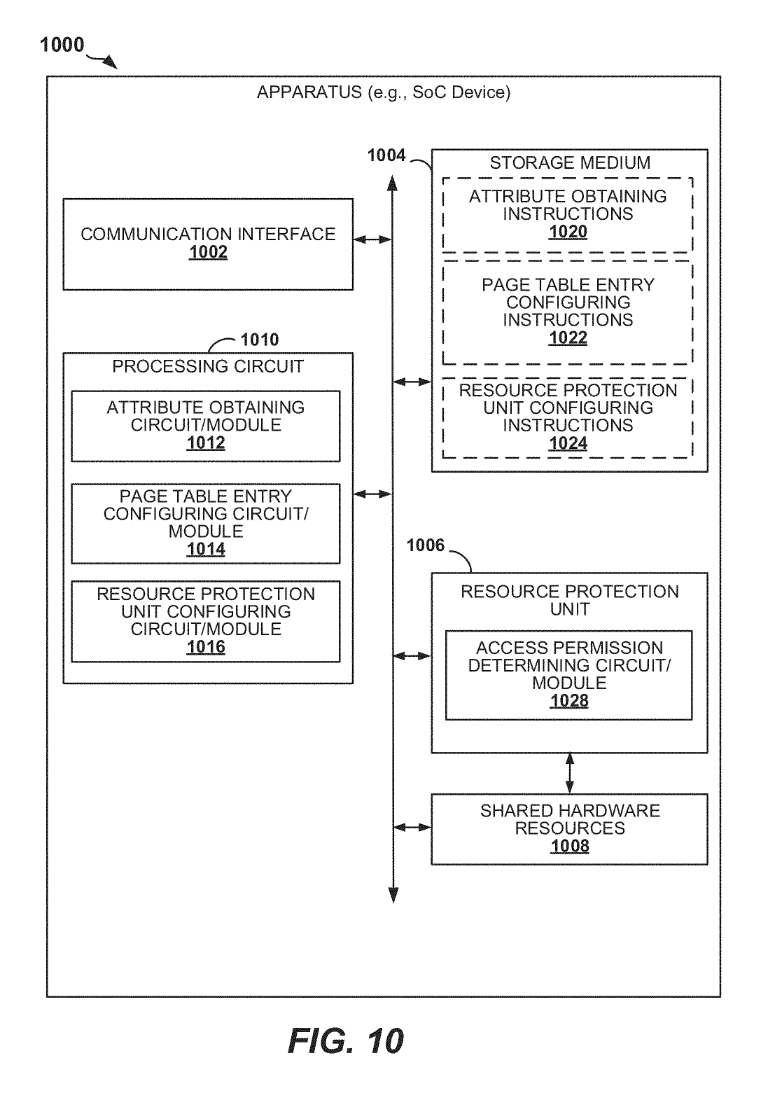

FIG. 10 is block diagram illustrating select components of an apparatus 1000 in accordance with various aspects of the disclosure. In some aspects, the apparatus 1000 may be an integrated circuit. For example, such integrated circuit may be included in a system-on-chip (SoC) device. In other aspects, the apparatus 1000 may be an electronic device (e.g., a mobile device, such as a smartphone, laptop computer, etc.). The apparatus 1000 includes a communication interface 1002, a storage medium 1004, a resource protection unit 1006, shared hardware resources 1008, and a processing circuit 1010. The processing circuit 1010 is coupled to or placed in electrical communication with each of the communication interface 1002, the storage medium 1004, the resource protection unit 1006, and the shared hardware resources 1008.

The communication interface 1002 may include, for example, one or more of: signal driver circuits, signal receiver circuits, amplifiers, signal filters, signal buffers, or other circuitry used to interface with a signaling bus or other types of signaling media.

The processing circuit 1010 is arranged to obtain, process and/or send data, control data access and storage, issue commands, and control other desired operations. The processing circuit 1010 may include circuitry adapted to implement desired programming provided by appropriate media in at least one example. In some instances, the processing circuit 1010 may include circuitry adapted to perform a desired function, with or without implementing programming. By way of example, the processing circuit 1010 may be implemented as one or more processors, one or more controllers, and/or other structure configured to execute executable programming and/or perform a desired function. Examples of the processing circuit 1010 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1010 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1010 are for illustration and other suitable configurations within the scope of the disclosure are also contemplated.

The processing circuit 1010 is adapted for processing, including the execution of programming, which may be stored on the storage medium 1004. In some aspects, the processing circuit 1010 may be referred to as a hardware configuration interface. In one example, such hardware configuration interface may be a hardware implementation of the programming front end 602 previously described with respect to FIG. 6. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 1010 may include one or more of: an attribute obtaining circuit/module 1012, a page table entry configuring circuit/module 1014, and a resource protection unit configuring circuit/module 1016.

The attribute obtaining circuit/module 1012 may include circuitry and/or instructions (e.g., attribute obtaining instructions 1020 stored on the storage medium 1004) adapted to obtain, at a hardware configuration interface, a physical page number associated with a secure resource, a domain identifier, and at least one memory attribute, wherein the hardware configuration interface is in communication with a resource protection unit that manages access to the secure resource.

The page table entry configuring circuit/module 1014 may include circuitry and/or instructions (e.g., page table entry configuring instructions 1022 stored on the storage medium 1004) adapted to configure a page table entry in a page table maintained at the resource protection unit, wherein the page table entry is configured to include the physical page number associated with the secure resource, the domain identifier, and the at least one memory attribute.

The resource protection unit configuring circuit/module 1016 may include circuitry and/or instructions (e.g., resource protection unit configuring instructions 1024 stored on the storage medium 1004) adapted to configure the resource protection unit and at least one additional resource protection unit with the same power management scheme or the same clock management scheme, wherein the resource protection unit and the at least one additional resource protection unit are configured to protect different secure resources.

The storage medium 1004 may represent one or more processor-readable devices for storing programming, electronic data, databases, or other digital information. The storage medium 1004 may also be used for storing data that is manipulated by the processing circuit 1010 when executing programming. The storage medium 1004 may be any available media that can be accessed by the processing circuit 1010, including portable or fixed storage devices, optical storage devices, and various other mediums capable of storing, containing and/or carrying programming. By way of example and not limitation, the storage medium 1004 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 1004 may be coupled to the processing circuit 1010 such that the processing circuit 1010 can read information from, and write information to, the storage medium 1004. That is, the storage medium 1004 can be coupled to the processing circuit 1010 so that the storage medium 1004 is at least accessible by the processing circuit 1010, including examples where the storage medium 1004 is integral to the processing circuit 1010 and/or examples where the storage medium 1004 is separate from the processing circuit 1010.

Programming/instructions stored by the storage medium 1004, when executed by the processing circuit 1010, causes the processing circuit 1010 to perform one or more of the various functions and/or process steps described herein. For example, the storage medium 1004 may include one or more of: attribute obtaining instructions 1020, page table entry configuring instructions 1022, and resource protection unit configuring instructions 1024. Thus, according to one or more aspects of the disclosure, the processing circuit 1010 is adapted to perform (in conjunction with the storage medium 1004) any or all of the processes, functions, steps and/or routines for any or all of the apparatuses described herein. As used herein, the term “adapted” in relation to the processing circuit 1010 may refer to the processing circuit 1010 being one or more of configured, employed, implemented, and/or programmed (in conjunction with the storage medium 1004) to perform a particular process, function, step and/or routine according to various features described herein.

The resource protection unit 1006 may include an access permission determining circuit module 1028. For example, the resource protection unit 1006 may interface with the shared hardware resources 1008 and may determine an access permission for a resource access transaction. In an aspect, the access permission determining circuit module 1028 may determine an access permission for a resource access transaction by obtaining a resource access transaction directed to secure resources (e.g., secure resources in the shared hardware resources 1008), the resource access transaction including at least the physical page number, determining the page table entry in the page table associated with the physical page number, and determining whether the page table entry indicates the access permission.

The shared hardware resources 1008 may represent one or more memory devices and may comprise any of the memory technologies listed above or any other suitable memory technology. The shared hardware resources 1008 may store information used by one or more of the components of the apparatus 1000. The shared hardware resources 1008 also may be used for storing data that is manipulated by the processing circuit 1010 or some other component of the apparatus 1000. In some implementations, the shared hardware resources 1008 and the storage medium 1004 are implemented as a common memory component.

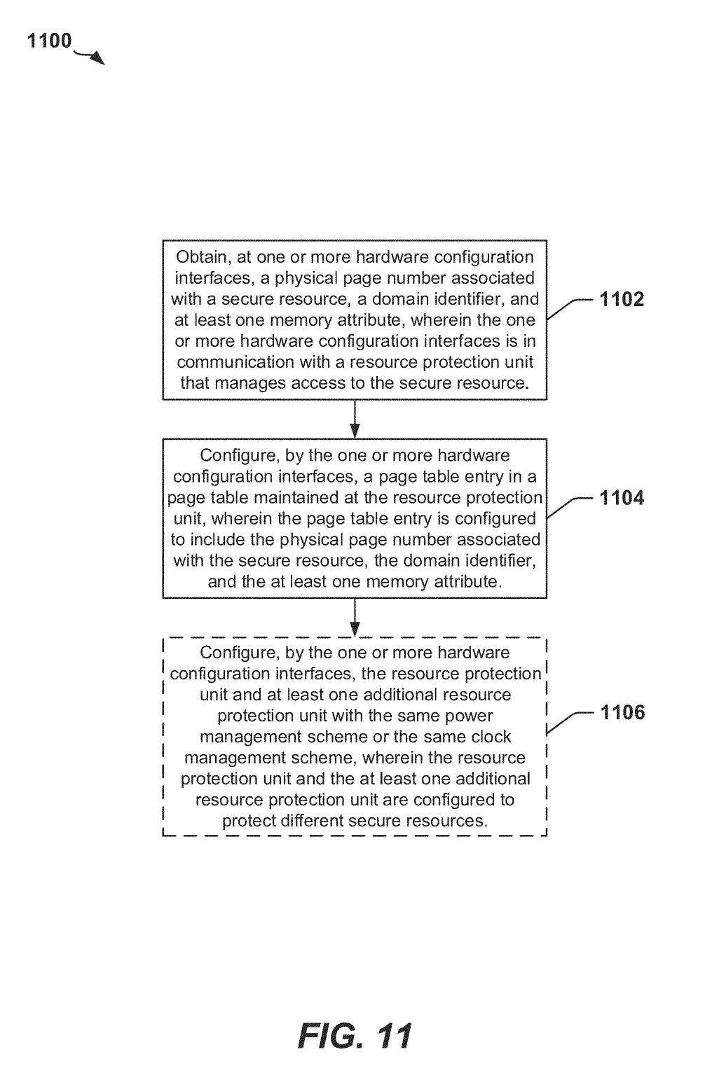

With the above in mind, examples of operations according to the disclosed aspects will be described in more detail in conjunction with the flowchart of FIG. 11. For convenience, the operations of FIG. 11 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 11 is a flowchart 1100 illustrating a method for an apparatus. It should be understood that the operations in FIG. 11 represented with dashed lines represent optional operations.

The apparatus obtains, at one or more hardware configuration interfaces, a physical page number associated with a secure resource, a domain identifier, and at least one memory attribute, wherein the one or more hardware configuration interfaces is in communication with a resource protection unit that manages access to the secure resource 1102. The apparatus configures, by the one or more hardware configuration interfaces, a page table entry in a page table maintained at the resource protection unit, wherein the page table entry is configured to include the physical page number associated with the secure resource, the domain identifier, and the at least one memory attribute 1104. In an aspect, the resource protection unit processes a resource access transaction when an access permission for the resource access transaction is determined in the page table. In an aspect, the access permission for the resource access transaction is determined by obtaining, at the resource protection unit, the resource access transaction directed to the secure resource, the resource access transaction including at least the physical page number, determining the page table entry in the page table associated with the physical page number, and determining whether the page table entry indicates the access permission. In an aspect, the determination whether the page table entry indicates the access permission is based on the domain identifier and the at least one memory attribute associated with the physical page number.

The apparatus configures, by the one or more hardware configuration interfaces, the resource protection unit and at least one additional resource protection unit with the same power management scheme or the same clock management scheme, wherein the resource protection unit and the at least one additional resource protection unit are configured to protect different secure resources 1106. In an aspect, the protection unit is a register protection unit, a memory protection unit, or an address protection unit. In an aspect, the apparatus configures the page table entry by halting, at the resource protection unit, operation of a translation buffer unit configured as a resource access control filter, updating one or more translation lookaside buffers and resuming the operation of the translation buffer unit, in an aspect, the apparatus updates the one or more translation lookaside buffers by writing to a software interrupt register, or implementing a command que that is configured to update the translation lookaside buffers.

In an aspect, the one or more hardware configuration interfaces includes a single hardware configuration interface capable of managing the secure resource and other secure resources. In an aspect, the one or more hardware configuration interfaces includes at least a first hardware configuration interface capable of managing the secure resource and other secure resources, and a second hardware configuration interface capable of managing the secure resource and the other secure resources. For example, the first hardware configuration interface is controlled by a first subsystem and the second hardware configuration interface is controlled by a second subsystem.

### Second Exemplary Device and Method

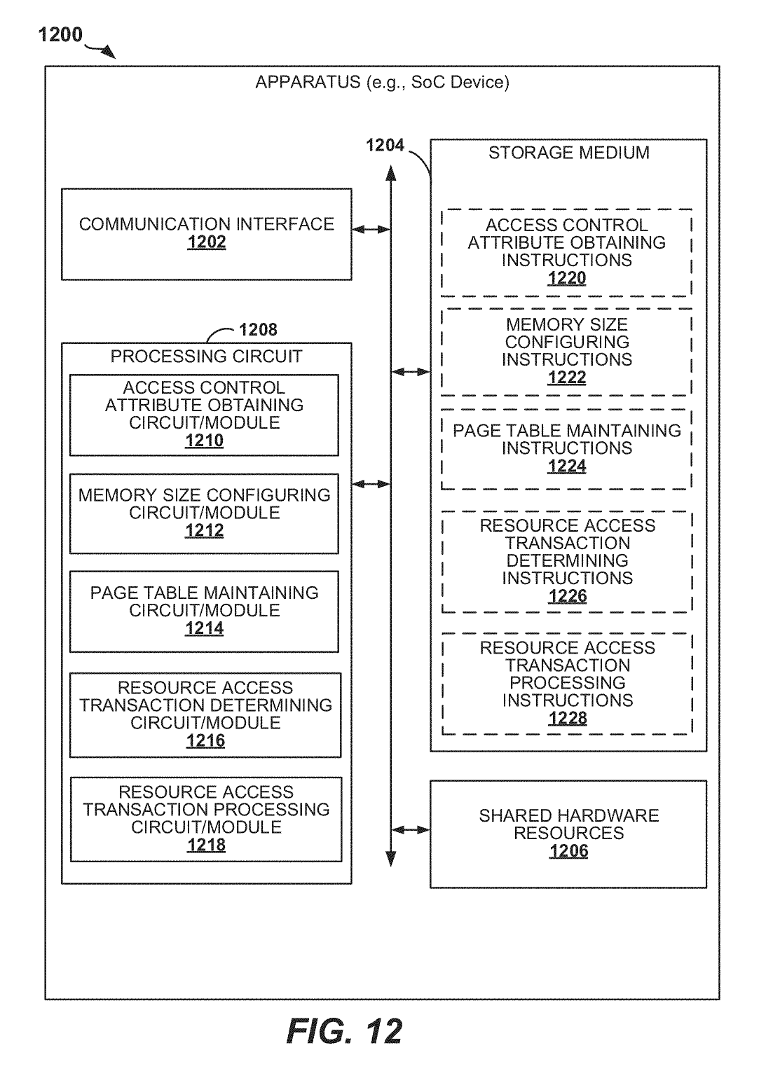

FIG. 12 is block diagram illustrating select components of an apparatus 1200 in accordance with various aspects of the disclosure. In some aspects, the apparatus 1200 may be an integrated circuit. For example, such integrated circuit may be included in a system-on-chip (SoC) device. In other aspects, the apparatus 1200 may be an electronic device (e.g., a mobile device, such as a smartphone, laptop computer, etc.). The apparatus 1200 includes a communication interface 1202, a storage medium 1204, shared hardware resources 1206, and a processing circuit 1208. The processing circuit 1208 is coupled to or placed in electrical communication with each of the communication interface 1202, the storage medium 1204, and the shared hardware resources 1206.

The communication interface 1202 may include, for example, one or more of: signal driver circuits, signal receiver circuits, amplifiers, signal filters, signal buffers, or other circuitry used to interface with a signaling bus or other types of signaling media.

The processing circuit 1208 is arranged to obtain, process and/or send data, control data access and storage, issue commands, and control other desired operations. The processing circuit 1208 may include circuitry adapted to implement desired programming provided by appropriate media in at least one example. In some instances, the processing circuit 1208 may include circuitry adapted to perform a desired function, with or without implementing programming. By way of example, the processing circuit 1208 may be implemented as one or more processors, one or more controllers, and/or other structure configured to execute executable programming and/or perform a desired function. Examples of the processing circuit 1208 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1208 may also be implemented as a combination of computing components, such as a combination of a DSP and a microprocessor, a number of microprocessors, one or more microprocessors in conjunction with a DSP core, an ASIC, and a microprocessor, or any other number of varying configurations. These examples of the processing circuit 1208 are for illustration and other suitable configurations within the scope of the disclosure are also contemplated.

The processing circuit 1208 is adapted for processing, including the execution of programming, which may be stored on the storage medium 1204. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 1208 may include one or more of: an access control attribute obtaining circuit/module 1210, memory size configuring circuit/module 1212, a page table maintaining circuit/module 1214, a resource access transaction determining circuit/module 1216, and a resource access transaction processing circuit/module 1218.

The access control attribute obtaining circuit/module 1210 may include circuitry and/or instructions (e.g., access control attribute obtaining instructions 1220 stored on the storage medium 1204) adapted to obtain, at the memory management unit, the first set of access control attributes associated with the non-secure hardware resources and the second set of access control attributes associated with the secure hardware resources from a hardware configuration interface.

The memory size configuring circuit/module 1212 may include circuitry and/or instructions (e.g., memory size configuring instructions 1222 stored on the storage medium 1204) adapted to configure, at the memory management unit, a size of the second region of the memory device.

The page table maintaining circuit/module 1214 may include circuitry and/or instructions (e.g., page table maintaining instructions 1224 stored on the storage medium 1204) adapted to maintain a page table that includes a number of page table entries, wherein a first page table entry includes the first set of access control attributes and a second page table includes the second set of access control attributes.

The resource access transaction determining circuit/module 1216 may include circuitry and/or instructions (e.g., resource access transaction determining instructions 1226 stored on the storage medium 1204) adapted to determine, at the memory management unit, whether to allow or reject the resource access transaction based on a first set of access control attributes associated with non-secure hardware resources when the resource access transaction is directed to the non-secure hardware resources, and a second set of access control attributes associated with secure hardware resources when the resource access transaction is directed to the secure hardware resources.

The resource access transaction processing circuit/module 1218 may include circuitry and/or instructions (e.g., resource access transaction processing instructions 1228 stored on the storage medium 1204) adapted to process the resource access transaction based on the determination.

The storage medium 1204 may represent one or more processor-readable devices for storing programming, electronic data, databases, or other digital information. The storage medium 1204 may also be used for storing data that is manipulated by the processing circuit 120$ when executing programming. The storage medium 1204 may be any available media that can be accessed by the processing circuit 1208, including portable or fixed storage devices, optical storage devices, and various other mediums capable of storing, containing and/or carrying programming. By way of example and not limitation, the storage medium 1204 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 1204 may be coupled to the processing circuit 1208 such that the processing circuit 1208 can read information from, and write information to, the storage medium 1204. That is, the storage medium 1204 can be coupled to the processing circuit 1208 so that the storage medium 1204 is at least accessible by the processing circuit 1208, including examples where the storage medium 1204 is integral to the processing circuit 1208 and/or examples where the storage medium 1204 is separate from the processing circuit 1208.

Programming/instructions stored by the storage medium 1204, when executed by the processing circuit 1208, causes the processing circuit 1208 to perform one or more of the various functions and/or process steps described herein. For example, the storage medium 1204 may include one or more of: access control attribute obtaining instructions 1220, memory size configuring instructions 1222, page table maintaining instructions 1224, resource access transaction determining instructions 1226, and resource access transaction processing instructions 1228. Thus, according to one or more aspects of the disclosure, the processing circuit 1208 is adapted to perform (in conjunction with the storage medium 1204) any or all of the processes, functions, steps and/or routines for any or all of the apparatuses described herein. As used herein, the term “adapted” in relation to the processing circuit 1208 may refer to the processing circuit 1208 being one or more of configured, employed, implemented, and/or programmed (in conjunction with the storage medium 1204) to perform a particular process, function, step and/or routine according to various features described herein.

The shared hardware resources 1206 may represent one or more memory devices and may comprise any of the memory technologies listed above or any other suitable memory technology. The shared hardware resources 1206 may store information used by one or more of the components of the apparatus 1200. The shared hardware resources 1206 also may be used for storing data that is manipulated by the processing circuit 1208 or some other component of the apparatus 1000. In some implementations, the shared hardware resources 1206 and the storage medium 1204 are implemented as a common memory component.

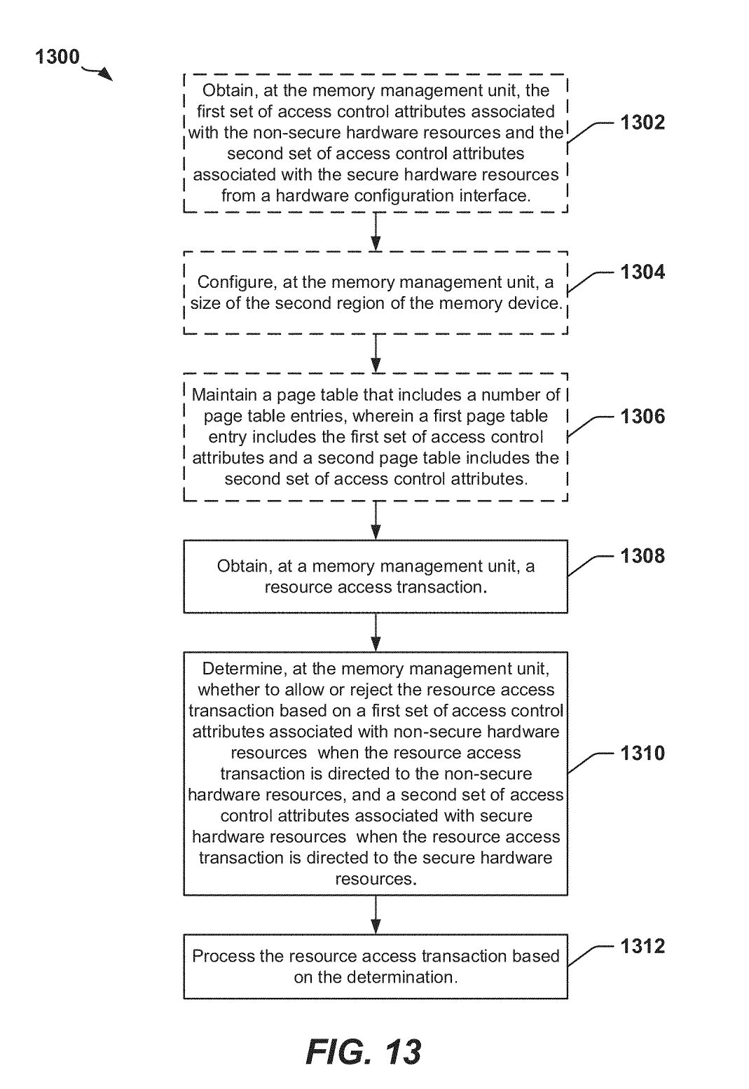

With the above in mind, examples of operations according to the disclosed aspects will be described in more detail in conjunction with the flowchart of FIG. 13. For convenience, the operations of FIG. 13 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 13 is a flowchart 1300 illustrating a method for an apparatus. It should be understood that the operations in FIG. 13 represented with dashed lines represent optional operations.

The apparatus obtains, at the memory management unit, the first set of access control attributes associated with the non-secure hardware resources and the second set of access control attributes associated with the secure hardware resources from a hardware configuration interface 1302. In an aspect, the non-secure hardware resources may include a first memory region in a memory device and the secure hardware resources may include a second region in the memory device. In an aspect, the memory management unit may be a system memory management unit.

The apparatus configures, at the memory management unit, a size of the second region of the memory device 1304. The apparatus maintains a page table that includes a number of page table entries, wherein a first page table entry includes the first set of access control attributes and a second page table includes the second set of access control attributes 1306. The apparatus obtains, at a memory management unit, a resource access transaction 1308. In an aspect, the obtained resource access transaction may be generated from a device external to a central processing unit. In an aspect, the device external to a central processing unit may be authorized to access the secure hardware resources. In an aspect, the resource access transaction includes a domain identifier indicating secure domain or a non-secure domain.

The apparatus determines, at the memory management unit, whether to allow or reject the resource access transaction based on a first set of access control attributes associated with non-secure hardware resources when the resource access transaction is directed to the non-secure hardware resources, and a second set of access control attributes associated with secure hardware resources when the resource access transaction is directed to the secure hardware resources 1310. The apparatus processes the resource access transaction based on the determination 1312.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like. As used herein, the term “obtaining” may include one or more actions including, but not limited to, receiving, generating, determining, or any combination thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method for an apparatus comprising:
obtaining, at one or more hardware configuration interfaces, a physical page number associated with a secure resource, a domain identifier, and at least one memory attribute, wherein the one or more hardware configuration interfaces is in communication with a resource protection unit that manages access to the secure resource; and
configuring, by the one or more hardware configuration interfaces, a page table entry in a page table maintained at the resource protection unit, wherein the page table entry is configured to include the physical page number associated with the secure resource, the domain identifier, and the at least one memory attribute,
wherein the resource protection unit processes a resource access transaction when an access permission for the resource access transaction is determined in the page table.

2. The method of claim 1, wherein the access permission for the resource access transaction is determined by:
obtaining, at the resource protection unit, the resource access transaction directed to the secure resource, the resource access transaction including at least the physical page number,
determining the page table entry in the page table associated with the physical page number, and
determining whether the page table entry indicates the access permission.

3. The method of claim 2, wherein the determination whether the page table entry indicates the access permission is based on the domain identifier and the at least one memory attribute associated with the physical page number.

4. The method of claim 1, further comprising,
configuring, by the one or more hardware configuration interfaces, the resource protection unit and at least one additional resource protection unit with the same power management scheme or the same clock management scheme, wherein the resource protection unit and the at least one additional resource protection unit are configured to protect different secure resources.

5. The method of claim 1, wherein the resource protection unit is a roister protection unit, a memory protection unit, or an address protection unit.

6. The method of claim 1, wherein configuring the page table entry comprises:
halting, at the resource protection unit, operation of a translation buffer unit configured as a resource access control filter;
updating one or more translation lookaside buffers; and
resuming the operation of the translation buffer unit.

7. The method of claim 6, wherein the updating the one or more translation lookaside buffers comprises:
writing to a software interrupt register, or
implementing a command que that is configured to update the one or more translation lookaside buffers.

8. The method of claim 1, wherein the one or more hardware configuration interfaces comprises a single hardware configuration interface capable of managing the secure resource and other secure resources.

9. The method of claim 1, wherein the one or more hardware configuration interfaces comprises at least a first hardware configuration interface capable of managing the secure resource and other secure resources, and a second hardware configuration interface capable of managing the secure resource and the other secure resources.

10. The method of claim 9, wherein the first hardware configuration interface is controlled by a first subsystem and the second hardware configuration interface is controlled by a second subsystem.

11. An apparatus comprising:
a secure hardware resource; and
a processing circuit coupled to the secure hardware resource, the processing circuit configured to
obtain, at one or more hardware configuration interfaces, a physical page number associated with a secure resource, a domain identifier, and at least one memory attribute, wherein the one or more hardware configuration interfaces is in communication with a resource protection unit that manages access to the secure resource; and
configure, by the one or more hardware configuration interfaces, a page table entry in a page table maintained at the resource protection unit, wherein the page table entry is configured to include the physical page number associated with the secure resource, the domain identifier, and the at least one memory attribute,
wherein the resource protection unit processes a resource access transaction when an access permission for the resource access transaction is determined in the page table.

12. The apparatus of claim 11, wherein the resource protection unit is configured to:
obtain, at the resource protection unit, a resource access transaction directed to the secure resource, the resource access transaction including at least the physical page number,
determine the page table entry in the page table associated with the physical page number, and
determine whether the page table entry indicates the access permission.

13. The apparatus of claim 11, wherein the processing circuit is further configured to:
configure, by the one or more hardware configuration interfaces, the resource protection unit and at least one additional resource protection unit with the same power management scheme or the same clock management scheme, wherein the resource protection unit and the at least one additional resource protection unit are configured to protect different secure resources.

14. The apparatus of claim 11, wherein the processing circuit configured to configure the page table entry is further configured to:
halt, at the resource protection unit, an operation of a translation buffer unit configured as a resource access control filter;
update one or more translation lookaside buffers; and
resume the operation of the translation buffer unit.

15. A method for an apparatus comprising:
obtaining, at a memory management unit, a resource access transaction;
determining, at the memory management unit, whether to allow or reject the resource access transaction based on
a first set of access control attributes associated with non-secure hardware resources when the resource access transaction is directed to the non-secure hardware resources, and
a second set of access control attributes associated with secure hardware resources when the resource access transaction is directed to the secure hardware resources; and
processing the resource access transaction based on the determination.

16. The method of claim 15, further comprising:
maintaining a page table that includes a number of page table entries, wherein a first page table entry includes the first set of access control attributes and a second page table includes the second set of access control attributes.

17. The method of claim 15, further comprising:
obtaining, at the memory management unit, the first set of access control attributes associated with the non-secure hardware resources and the second set of access control attributes associated with the secure hardware resources from one or more hardware configuration interfaces.

18. The method of claim 15, wherein the non-secure hardware resources include a first memory region in a memory device and the secure hardware resources include a second region in the memory device.

19. The method of claim 18, further comprising:
configuring, at the memory management unit, a size of the second region of the memory device.

20. The method of claim 15, wherein the memory management unit is a system memory management unit, and wherein the obtained resource access transaction is generated from a device external to a central processing unit.

21. The method of claim 20, where the device external to a central processing unit is authorized to access the secure hardware resources.

22. The method of claim 15, where the resource access transaction includes a domain identifier indicating secure domain or a non-secure domain.

23. An apparatus comprising:
a secure hardware resource and a non-secure hardware resource; and
a processing circuit coupled to the secure hardware resource and the non-secure hardware resource, the processing circuit configured to
obtain, at a memory management unit, a resource access transaction;
determine whether to allow or reject the resource access transaction based on
a first set of access control attributes associated with the non-secure hardware resources when the resource access transaction is directed to the non-secure hardware resources, and
a second set of access control attributes associated with the secure hardware resources when the resource access transaction is directed to the secure hardware resources; and
process the resource access transaction based on the determination.

24. The apparatus of claim 23, wherein the processing circuit is further configured to:
maintain a page table that includes a number of page table entries, wherein a first page table entry includes the first set of access control attributes and a second page table includes the second set of access control attributes.

25. The apparatus of claim 23, wherein the processing circuit is further configured to:
obtain, at the memory management unit, the first set of access control attributes associated with the non-secure hardware resource and the second set of access control attributes associated with the secure hardware resource from one or more hardware configuration interfaces.

26. The apparatus of claim 23, wherein the non-secure hardware resource includes a first memory region in a memory device and the secure hardware resource includes a second region in the memory device.

27. The apparatus of claim 23, wherein the processing circuit is further configured to:
configure a size of the second region of a memory device.

28. The apparatus of claim 23, wherein the memory management unit is a system memory management unit, and wherein the obtained resource access transaction is generated from a device external to a central processing unit.

29. The apparatus of claim 28, where the device external to a central processing unit is authorized to access the secure hardware resource.

30. The apparatus of claim 23, where the resource access transaction includes a domain identifier indicating secure domain or a non-secure domain.
